(19) United States
(12) Patent Application Publication
(10) Pub. No.: US 2004/0214610 A1
(43) Pub. Date: Oct. 28, 2004

(54) Communication device having multiple displays

(76) Inventors: Tetsuo Tanemura, Yokohama City (JP); Kenji Kawaguchi, Saitama City (JP)

Correspondence Address: MOTOROLA INC, 600 NORTH US HIGHWAY 45, ROOM AS437, LIBERTYVILLE, IL, 60048-5343, US

(21) Appl. No.: 10/422,403

(22) Filed: Apr. 24, 2003

(51) Int. Cl. H04B 1/38

(52) U.S. Cl. 455/566; 455/575.1

(57) ABSTRACT

A portable communications device has a housing having a first section and a second section and a hinge coupling the first section to the second section such that the second section is movable between an open position and a closed position. A first display is located near the hinge and is viewable when the second section is in both the open position and the closed position. A second displays is located on an inner surface of the second section and is viewable when the second section is in the open position and obstructed from view when the second section is in the closed position.

### BACKGROUND OF THE INVENTION

The present invention relates generally to communication devices having multiple displays, and more particularly to portable radio communication devices having multiple displays.

Many portable communications devices, such as cellular telephones, include housings defining relatively large front and rear surfaces with thin sides. To keep the size of the device small, such devices sometimes have a foldable housing known as a clamshell design or a flip-phone. Referring to FIG. 1, an example of a clamshell design cellular telephone 10 is shown. The phone 10 has a first section 12 that houses circuitry, and includes a keypad 14 and microphone 16 for inputting information into the phone 10. A second section 18 has a display 20, such as an LCD or color LCD and a speaker 22 for outputting information. The first and second sections 12 and 18 are connected with a hinge 24 such that the second section 18 is movable between a first, open position (FIG. 1) and a second, closed position (FIG. 2). FIG. 2 is a front view of the phone 10 in the closed position. As can be seen, the second section 18 includes a second display 26. The second display 26 is provided to allow a user to view certain status information when the phone 10 is in the closed position and the first display 20 is not visible. The second display 26 may include, for example a row of icons indicating signal strength and battery charge. The second display 26 may also include a line for text information, such as date and time and phone status. Phone status typically includes information like missed call, SMS message received, email received, or caller-ID.

As cellular phones become more sophisticated and are used for more applications such as web surfing, taking digital pictures and sending and receiving MMS messages, there is a need for more display space. It is an object of the present invention to provide a clamshell type communications device having an increased display area.

### BRIEF DESCRIPTION OF THE DRAWINGS

The following detailed description of preferred embodiments of the invention will be better understood when read in conjunction with the appended drawings. For the purpose of illustrating the invention, there is shown in the drawings embodiments that are presently preferred. It should be understood, however, that the invention is not limited to the precise arrangement and instrumentalities shown. In the drawings:

FIG. 1 is a perspective view of a prior art cellular telephone in an open position;

FIG. 2 is a front view of the cellular phone of FIG. 1 in a closed position;

FIG. 3 is a front view of a communication device in a closed position in accordance with a first embodiment of the present invention;

FIG. 4 is a side view of the communication device of FIG. 3 in the closed position;

FIG. 5 is a rear view of the communication device of FIG. 3 in the closed position;

FIG. 6 is a front view of the communication device of FIG. 3 in an open position;

FIG. 7 is a side view of the communication device of FIG. 3 in the open position;

FIG. 8 is a front view of a communication device in a closed position in accordance with a second embodiment of the present invention;

FIG. 9 is a side view of the communication device of FIG. 8 in the closed position;

FIG. 10 is a front view of the communication device of FIG. 8;

FIG. 11 is a perspective view of a second housing section of the communication device of FIG. 8; and

FIG. 12 is a perspective view of a first housing section of the communication device of FIG. 8.

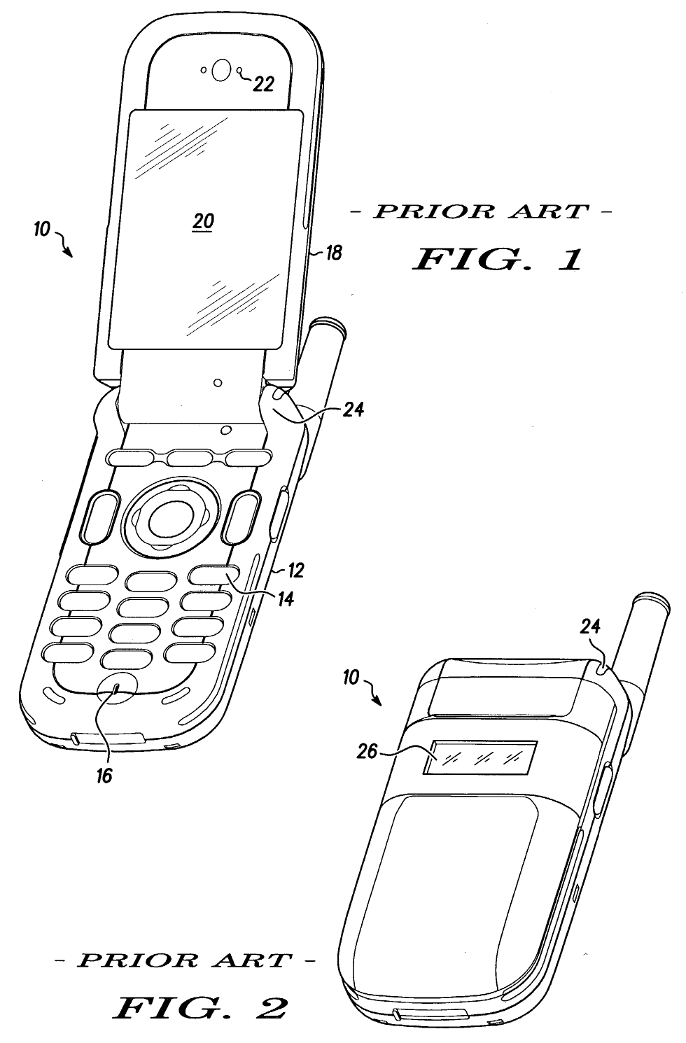

### DETAILED DESCRIPTION OF PREFERRED EMBODIMENTS

The detailed description set forth below in connection with the appended drawings is intended as a description of the presently preferred embodiments of the invention, and is not intended to represent the only forms in which the present invention may be practiced. It is to be understood that the same or equivalent functions may be accomplished by different embodiments that are intended to be encompassed within the spirit and scope of the invention. In the drawings, like numerals are used to indicate like elements throughout.

The present invention provides a clamshell type portable communications device having a supplementary display screen that can be viewed when the device is both opened and closed. When the device is opened, the supplementary display relieves the primary display screen from having to display status information and thus, the primary screen has more space for displaying information such as SMS and MMS messages, emails, web pages, etc.

Accordingly, in one embodiment, the present invention is a communications device having a housing including a first section and a second section and a hinge coupling the first section to the second section such that the second section is movable between an open position and a closed position. The device includes a first display that is viewable when the second section is in both the open position and the closed position, and a second display that is viewable when the second section is in the open position and obstructed from view when the second section is in the closed position.

In another embodiment, the present invention is a portable communications device including a housing having a first section and a second section and a hinge coupling the first section to the second section such that the second section is movable between an open position and a closed position. A first display is attached to the hinge and rotatable therewith such that the first display is viewable when the second section is in both the open position and the closed position. A second display is located on an inner surface of the second section and is viewable when the second section is in the open position and obstructed from view when the second section is in the closed position.

In yet another embodiment, the present invention is a portable communications device including a first housing section having a front side including a keypad and a back side, a second housing section having a front side and a back side, and a hinge coupling the first housing section to the second housing section such that the second housing section is movable between an open position and a closed position. A first display is located at one end of the first housing section proximate to the hinge and is viewable when the second section is in both the open position and the closed position. A second display is located on an inner surface of the second housing section and is viewable when the second section is in the open position and obstructed from view when the second section is in the closed position.

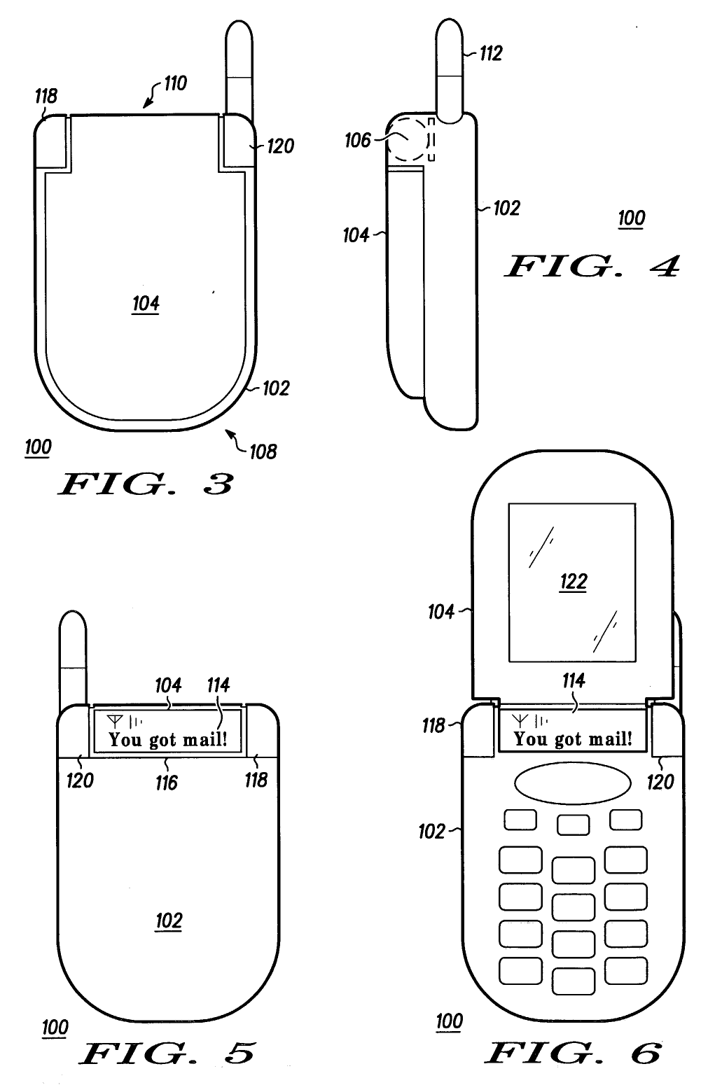

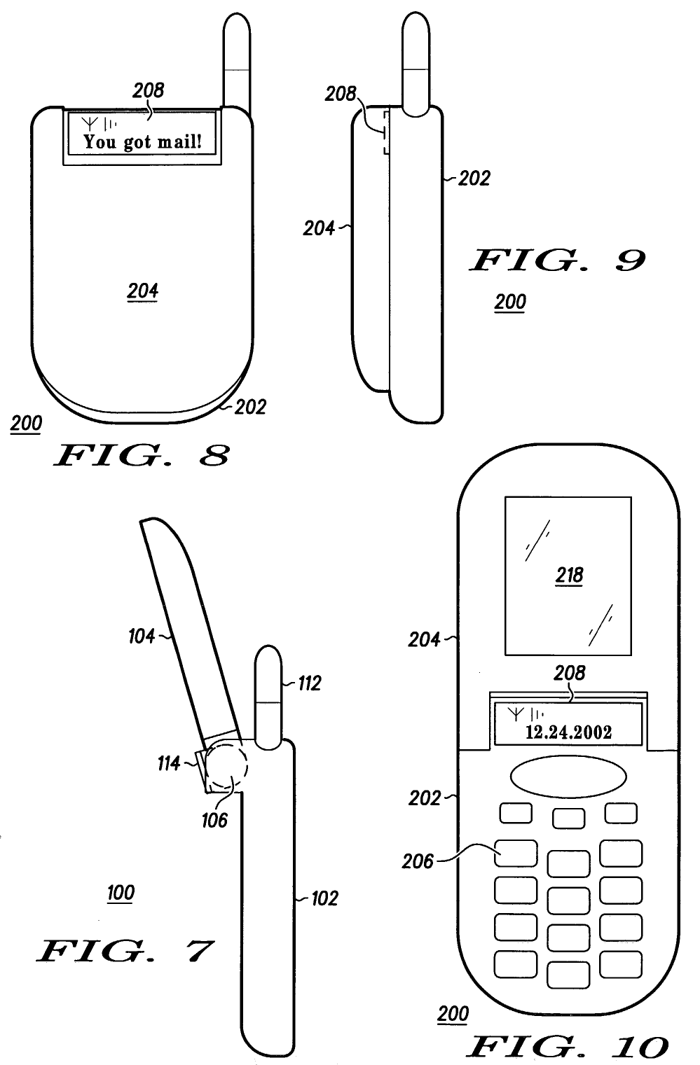

Referring now to FIGS. 3 through 7, a first embodiment of a portable communications device 100 in accordance with the present invention is shown. The communications device 100 is a clamshell type design and includes a housing having a first section 102, a second section 104 and a hinge 106 coupling the first section 102 to the second section 104 such that the second section 104 is movable between an open position (FIGS. 6 and 7) and a closed position (FIGS. 3 through 5). Such clamshell type communication devices are well known in the art and are commercially available from Motorola Inc. of Schaumburg, Ill., among others.

The communications device 100 is sized and shaped to fit in a shirt or pants pocket or holster and is easily held in the palm of an adult hand. For example, the first and second sections, which are similarly sized, may be from about 6.0 cm to 10.0 cm in length and from about 4.0 cm to 5.0 cm in width, and the device 100 may have a thickness of between about 1.5 cm to 2 cm in the closed position. However, devices of smaller and larger sizes may be made and the present invention is not meant to be limited by any specific size dimensions. The first and second sections 102 and 104, as well as the hinge 106 may be formed of a durable material such as metal or plastic, as is known in the art. The first and second sections 102 and 104 may be generally square or rectangular shaped with either one or both ends being rounded. In the embodiment shown, one end 108 of the first and second sections 102 and 104 has rounded corners and the other end 110 of the first and second sections 102 and 104 is more square shaped.

FIG. 3 is a front view of the device 100 in the closed position in which the second section 104 covers an inner side of the first section 102. FIG. 4 is a side view of the device 100 in the closed position and clearly shows the first and second sections 102 and 104. The hinge 106 is shown in dotted lines. An antenna 112 is also shown. However, the device may have either an external antenna, as shown, or an internal antenna. FIG. 4 is a rear view of the device 100 in the closed position. The device 100 includes a first display 114 that is viewable when the second section 104 is in the closed position. More particularly, the first display 114 is located on the hinge 106 and rotates therewith when the second section 104 is moved between the open position and the closed position.

The end of the first section 102 that is coupled to the hinge 106 is U-shaped having a base 116 and two arms 118 and 120 extending outwardly from the base 116. The first display 114 is viewable from between the two arms 118 and 120 at a backside of the first section 102 when the second section 104 is in the closed position. When the second section 104 is moved from the closed position to the open position, the hinge 106 and consequently the first display 114, rotates such that the first display 114 moves to a position in which is it viewable when the second section 104 is in the open position, as illustrated in FIG. 7. The hinge 106, which may comprise a rod, extends through the second section 104 and the ends of the rod extend into the arms 118 and 120.

Referring now to FIG. 6, the device 100 has a second display 122 located on an inner surface of the second section 104. The second display 122 is viewable when the second section 104 is in the open position and obstructed from view when the second section 104 is in the closed position. It is of particular note that in the open position, both the first and second displays 114 and 122 are simultaneously viewable.

In the presently preferred embodiment, the first display 114 is used to display status information such as date and time, battery level indication, caller identification, communications signal strength, call duration, and an amount of money charged for a call. For example, the first display 114 may include a row for displaying icons like an antenna and bars indicating a network connection and carrier signal strength, respectively, as well as a battery icon that indicates the amount of charge stored in a battery that powers the device. The first display 114 may include a second row for displaying alphanumeric information, such as the date and time, caller ID when a call is being received, email or message alert, etc. It is noted that the first display 114 rotates 180 degrees from the open position to the closed position and vice-versa. Thus, the data displayed on the first display 114 is flipped by a software routine stored in the device 100 so that the displayed information is always displayed in a proper orientation for a user to read it. The first display 114 may also be used for different purposes when the device 100 is in the opened and closed positions. For example, when the device 100 is in the closed position, the first display 114 displays status information, such as date and time, user name, carrier strength, etc. and when the device 100 is in the opened position, the display 114 could act as an input device. That is, the display 114 could display soft keys or buttons that lie directly below selections displayed on the second screen 122 and the display 114 could have switches underlying it so that when the displayed (virtual) buttons are depressed, the corresponding selection is made or command executed.

In contrast, the second display 122 is generally a larger display, for example 5.0 cm by 4.0 cm, and is used to display web pages, email messages, SMS or MMS messages, pictures, icons, menus, etc. Thus, the second display 122 has an area that is substantially larger than an area of the first display 114. In the presently preferred embodiment, the first and second displays 114 and 122 are LCD screens, and preferably the second display 122 is a color LCD. Also, in the presently preferred embodiment, when the second section 104 is in the closed position, the first display 114 is powered on and the second display 122 is powered off. This allows the device 100 to conserve battery charge when the second screen 122 is not viewable.

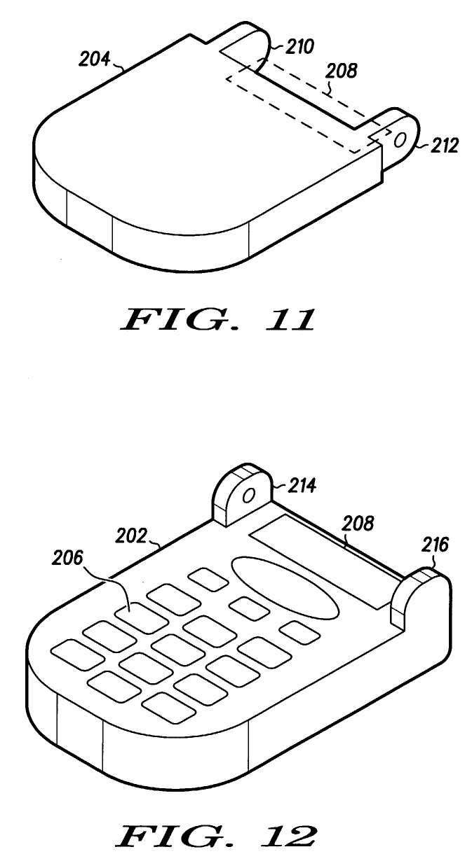

Referring now to FIGS. 8 through 12, a second embodiment of a communications device 200 in accordance with the present invention is shown. The communications device 200 includes a first housing section 202 and a second housing section 204. The first housing section 202 has a front side and a backside. As shown in FIG. 10, the front side of the first housing section 202 may include a keypad 206 that allows a user to enter commands and data such as a phone number, call instruction, text message, etc. A hinge (FIGS. 11 and 12) couples the first housing section 202 to the second housing section 204 such that the second housing section 204 is movable between an open position (FIG. 10) and a closed position (FIGS. 8 and 9). In the closed position, the second housing section 204 covers the keypad 206.

A first display 208 is located at one end of the first housing section 202 proximate to the hinge. The first display 208 is viewable when the second section 204 is in both the open position and the closed position. Referring to FIG. 11, a perspective view of the second housing section 204 is shown. As previously discussed, the second housing section 204 is coupled to the first housing section 202 via a hinge. In a presently preferred embodiment, the second housing section 204 includes two arms 210 and 212 that extend outwardly from an end thereof. The first display 208 is visible between the two arms 210 and 212. The two arms 210 and 212 are offset from the edge or corner of the second housing section. Referring now to FIG. 12, a perspective view of the first housing section 202 is shown. The first housing section 202 includes two arms 214 and 216 that extend upwardly from the front side thereof. When the first and second housing sections 202 and 204 are joined, the arms 210, 214 and 212, 216 abut each other and may be coupled for instance, by a rod (not shown) extending therebetween. As previously discussed, the first display 208 is visible from between the arms 210, 212, 214 and 216 in both the open and closed positions. It should be understood by those of skill in the art that the hinge structure disclosed and shown in FIGS. 11 and 12 is just one embodiment of a suitable hinge structure and that other hinge structures may be used to connect the first and second housing sections 202 and 204 that allow the first and second displays to be simultaneously viewed when the device is in the open position. For example, some cellular devices currently available include a twisting type hinge that allow the second housing section 204 to not only be moved between the opened and closed positions, but also to rotate when in the opened position.

The second housing section 204 includes a second display 218 (FIG. 10) located on an inner surface thereof. The second display 218 is viewable when the second section 204 is in the open position and obstructed from view when the second section 204 is in the closed position. Preferably, when the second section 204 is in the closed position, the first display 208 is powered on and the second display 218 is powered off.

As with the first embodiment, in this embodiment, the first display 208 preferably displays status information including at least one of date and time, battery level indication, caller identification, communications signal strength, call duration, and an amount of money charged for a call. However, as will be appreciated by those of skill in the art, many other messages and icons may be displayed on the first display 208. Preferably, the second display 218 has an area that is substantially larger than an area of the first display 208. The first display 208 may be an LED or LCD and the second display 218 is preferably a color LCD.

The description of the preferred embodiments of the present invention have been presented for purposes of illustration and description, but is not intended to be exhaustive or to limit the invention to the forms disclosed. Thus, changes could be made to the embodiments described above without departing from the inventive concept thereof. As will be appreciated, the present invention provides the advantage that when the second section is in the closed position, only the first display is viewable and the second display and the user interface (keypad) are obstructed from view, while in the open position, the first display, the second display, and the keypad are all simultaneously viewable. It is understood, therefore, that this invention is not limited to the particular embodiments disclosed, but covers modifications within the spirit and scope of the present invention as defined by the appended claims.

1. A portable communications device comprising:
a housing having a first section and a second section and a hinge coupling the first section to the second section such that the second section is movable between an open position and a closed position;
a first display viewable when the second section is in both the open position and the closed position; and
a second display viewable when the second section is in the open position and obstructed from view when the second section is in the closed position.

2. The portable communications device of claim 1, wherein the second display is located on an inner surface of the second section.

3. The portable communications device of claim 2, wherein the first display is located on the hinge and rotates therewith when the second section is moved between the open position and the closed position.

4. The portable communications device of claim 3, wherein an end of the first section coupled to the hinge is U-shaped having a base and two arms extending outwardly from the base, and the first display is viewable from between the two arms at a back side of the first section when the second section is in the closed position and viewable simultaneously with the second display from a front side of the first section when the second section is in the open position.

5. The portable communications device of claim 2, wherein the first display is located on an inner surface of the first section proximate to the hinge.

6. The portable communications device of claim 5, wherein the first and second sections have comlementary arms extending from respective ends thereof that mate to form the hinge.

7. The portable communications device of claim 1, wherein when the housing is in the closed position, the first display is powered on and the second display is powered off.

8. The portable communications device of claim 1, wherein the first display displays alphanumeric status information including at least one of date and time, battery level indication, caller identification, communications signal strength, call duration, and an amount of money charged for a call.

9. The portable communications device of claim 1, wherein the second display has an area that is substantially larger than an area of the first display.

10. The portable communications device of claim 1, wherein the second display comprises a color LCD.

11. A portable communications device comprising:
a housing having a first section and a second section and a hinge coupling the first section to the second section such that the second section is movable between an open position and a closed position;
a first display attached to the hinge and rotatable therewith such that the first display is viewable when the second section is in both the open position and the closed position; and
a second display located on an inner surface of the second section, the second display being viewable when the second section is in the open position and obstructed from view when the second section is in the closed position.

12. The portable communications device of claim 11, wherein the first display is viewable from a back side of the first section when the second section is in the closed position and viewable simultaneously with the second display from a front side of the first section when the second section is in the open position.

13. The portable communications device of claim 11, wherein when the housing is in the closed position, the first display is powered on and the second display is powered off.

14. The portable communications device of claim 11, wherein the first display displays status information including at least one of date and time, battery level indication, caller identification, communications signal strength, call duration, and an amount of money charged for a call.

15. The portable communications device of claim 11, wherein the second display has an area that is substantially larger than an area of the first display.

16. The portable communications device of claim 11, wherein the second display comprises a color LCD.

17. A portable communications device comprising:
a first housing section having a front side and a back side, the front side including a keypad;
a second housing section having a front side and a back side;
a hinge coupling the first housing section to the second housing section such that the second housing section is movable between an open position and a closed position;
a first display located on a surface of the first housing section at one end thereof proximate to the hinge, the first display being viewable when the second section is in both the open position and the closed position; and
a second display located on an inner surface of the second housing section, the second display being viewable when the second section is in the open position and obstructed from view when the second section is in the closed position.

18. The portable communications device of claim 17, wherein the first and second housing sections have arms that extend therefrom, wherein the arms of the first section mate with the arms of the second section to form the hinge and wherein the first display is visible between the arms.

19. The portable communications device of claim 17, wherein when the housing is in the closed position, the first display is powered on and the second display is powered off.

20. The portable communications device of claim 17, wherein the first display displays status information including at least one of date and time, battery level indication, caller identification, communications signal strength, call duration, and an amount of money charged for a call.

21. The portable communications device of claim 17, wherein the second display has an area that is substantially larger than an area of the first display.

22. The portable communications device of claim 17, wherein the second display comprises a color LCD.
